(19) United States
(12) Patent Application Publication
(10) Pub. No.: US 2006/0117630 A1
(43) Pub. Date: Jun. 8, 2006

(54) Gripper card holder

(76) Inventors: Richard M. Raia, Lexington, MA (US); Lee Porter, Keene, NH (US); David Costa, Rowley, MA (US)

Correspondence Address: BANNER & WITCOFF, LTD., 28 STATE STREET, 28th FLOOR, BOSTON, MA, 02109-9601, US

(21) Appl. No.: 11/289,780

(22) Filed: Nov. 29, 2005

Related U.S. Application Data
(60) Provisional application No. 60/632,047, filed on Dec. 1, 2004.

(51) Int. Cl. G09F 7/22; G09F 3/20

(52) U.S. Cl. 40/658; 40/617

(57) ABSTRACT

The present invention is directed to an improved card holder comprising a pair of parallel arms connected to one another in a spaced apart relationship. A resilient gripping material is included, preferably as finger-like appendages, on at least a portion of the inside surfaces of the spaced apart arms, such that when an ID card or the like is inserted into the space between the arms, the resilient gripping material compresses sufficiently to allow insertion, but also provides a secure gripping for retention of the ID card or the like, thereby preventing slippage of the card from the holder. To remove the inserted ID card or the like, force adequate to overcome the gripping is applied to the card, thereby permitting removal of the card from the holder. The amount of force needed will vary with the nature and thickness of the card, the gripping material, and the like. The holding power will likewise vary.

### PRIORITY CLAIM

This application claims priority from commonly owned, copending U.S. Provisional Patent Application Ser. No. 60/632,047, filed 1 Dec. 2004, the disclosure of which is hereby incorporated herein by reference.

### SUMMARY OF THE INVENTION

The present invention relates to a card holder and, in particular, to a new and improved card holder which can hold an identification card or smart card, or carry a plurality of business cards or similar items, without the need for making holes in the cards. A smart card resembles a credit card in size and shape, but inside it is completely different. First of all, it has an inside—a normal credit card is a simple piece of plastic. The inside of a smart card usually contains an embedded microprocessor. In as smart card, the microprocessor replaces the usual magnetic stripe on a credit card or debit card.

The present invention is directed to an improved card holder comprising a pair of parallel arms connected to one another in a spaced apart relationship. A resilient gripping material is included, preferably as finger-like appendages, on at least a portion of the inside surfaces of the spaced apart arms, such that when an ID card or the like is inserted into the space between the arms, the resilient gripping material compresses sufficiently to allow insertion, but also provides a secure gripping for retention of the ID card or the like, thereby preventing slippage of the card from the holder. To remove the inserted ID card or the like, force adequate to overcome the gripping is applied to the card, thereby permitting removal of the card from the holder. The amount of force needed will vary with the nature and thickness of the card, the gripping material, and the like. The holding power will likewise vary.

Should the need arise to hold several business cards or two or more ID cards or smart cards (or combinations thereof), these materials could likewise be inserted between the fingers in the card holder wherein the bias of the resilient fingers is overcome as required to allow the insertion of the items. The inserted items thus would be maintained between the fingers by the bias, and would be removed from the holder as required, the fingers automatically readjusting themselves to accommodate the remaining items.

In another aspect of the present invention, identification cards are often provided with a slot near one edge, to enable the user to wear the card via an attachment device such as a bulldog clip, or a lanyard with an attachment device such as a standard O-ring, snap-buckle O-ring, swivel snap hook, metal swivel hook, or the like. Unfortunately, these slots often break at the edge, making it impossible for the user of the card to continue to wear it in the original desired manner. The holder of the present invention solves this problem by providing a simple and secure replacement point for the attachment of the broken card to an attachment device. Simply insert the broken card into the fingers of the holder, and, once secured therein, connect the desired attachment device to the slot in the holder.

Accordingly, one embodiment of the present invention is directed to a holder for card-like items comprising:
an outer shell having a pair of parallel arms connected in a spaced apart relationship forming one closed end, each arm having an inner and outer surface; and
a means for gripping one or more card-like items, positioned between the inner surfaces of the parallel arms.

Preferably, the outer shell of the holder is composed of a plastic material. More preferably, the plastic material is Acrylonitrile-Butadiene-Styrene (ABS).

Preferably, the gripping means for the holder comprises a resilient material. More preferably, the resilient gripping means is provided by fingers, at least one finger on each parallel arm extending inwardly from the inner surface of the parallel arm, the fingers forming a pathway just narrower than the card-like items. Advantageously, the fingers on each parallel arm are directly opposed to those on the opposite arm and point away from the opening of the pathway. In preferred embodiments, the resilient material forms a single insert that contains the fingers and attaches to both parallel arms. Preferably, the resilient material is composed of a silicone rubber.

Advantageously, the holder further comprises a means for hanging the closed end of the outer shell from another object. Preferably, the hanging means comprises an opening through the closed end of the holder. More preferably, the hanging means comprises an elongated top portion extending from the closed end of the outer shell and having an opening through the elongated top portion.

One especially preferred embodiment of the present invention has the following physical characteristics; the outer shell is composed of ABS plastic with an overall size of 0.75 inches square and 0.5 inches thick; the gripping means is provided by a single insert made of silicone rubber containing two fingers pointing inwardly from the inner surface of each parallel arm, the fingers directly opposed to those on the opposite arm and pointing away from the opening of the pathway; the hanging means is provided by an extended top portion containing a slot essentially perpendicular to the pathway, the slot being adapted to receive both rectangular and circular attachments.

### BRIEF DESCRIPTION OF THE DRAWINGS

FIG. 1, which includes drawings 1A (top view), 1B (side view) and 1C (perspective view), shows the preferred resilient finger insert 100 for the card holder 200 of the present invention.

FIG. 2 is a cross-sectional view, showing the preferred resilient finger insert 100 mounted in place between the spaced apart arms 201, 202 of the card holder 200 of the present invention.

FIG. 3 is a three-dimensional view, showing the preferred resilient finger insert 100 mounted in place between the spaced apart arms 201, 202 of the card holder 200 of the present invention.

### DETAILED DESCRIPTION OF THE PREFERRED EMBODIMENT

One commercial embodiment of the present invention is a device called a “Card Gripper”. It is intended to be used in place of a strap to hold a plastic ID card on a person. The gripping action of the card holder avoids the necessity for putting a slot (“slotting”) in the card to accommodate straps, lanyards or other attachment devices for display.

As illustrated in the drawings accompanying this specification, a preferred version of the “Card Gripper” is a small, approximately ¾ inch square×½ inch thick card holder composed of two unitary pieces; a hard molded plastic outer shell 200 and separate soft, silicone rubber inner finger member 100 inserted into the shell.

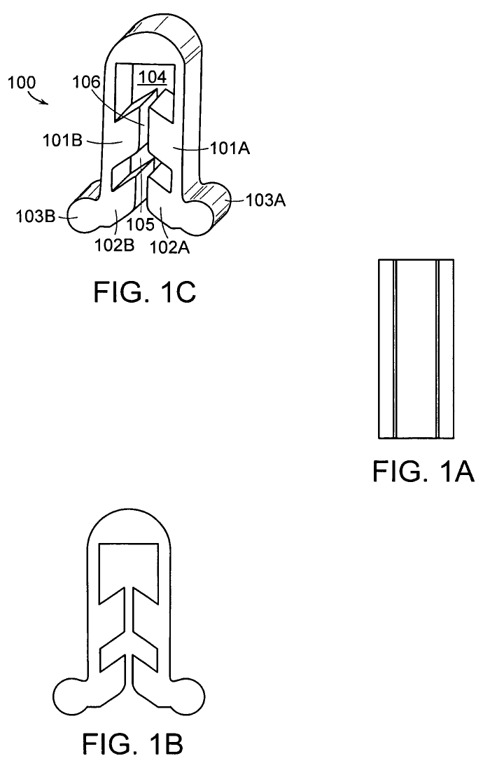

Preferred dimensions of the finger member 100 are provided in FIG. 1. All dimensions referenced there are in inches.

The plastic shell 200 should be made of plastic that is not brittle, as the arms 201, 202 may be required to provide some flex for holding certain cards. The preferred material for this embodiment is Acrylonitrile-Butadiene-Styrene (ABS) but it could be made in almost any type of plastic or even metal materials. Plastic is best for the present embodiment because it is non-conductive and non-corroding—both characteristics being particularly suitable for use with smart cards. The selection of other suitable plastics is within the ordinary skill of the artisan in this field.

In building the current preferred embodiment, the two separate pieces are formed individually, e.g., by molding. The silicone rubber finger piece 100 is then inserted into the rigid plastic body 200 and glued into place, e.g., at 201 and 202. Alternatively, these pieces could be injection molded in place by ‘charging’ the mold (‘insert molding’). Here, the silicone part is put into the mold first, and then the rigid plastic holder is molded around it. Alternative methods of construction are also within the ordinary skill of the art.

In the illustrated embodiment, there are four inner fingers (two on each side—101A, 101B, 102A, 102B) which are directly opposed and almost touching, such that they form a thin resilient slot (or pathway—106) into which the card is inserted. The card being of wider dimension than the slot, when inserted, compresses the fingers into the spaces 104, 105 around the fingers and creates a back pressure or gripping force. This gripping force keeps the card (not shown) from falling out—but the card can be removed by the user by pulling out with enough force—as the resilient fingers flex both inwardly and outwardly. If desired, the number of fingers could either be reduced or increased—depending upon the material used and the shape and size dimensions of the same. Likewise, the fingers could be arranged in patterns other than those illustrated, as long as the desired gripping ability is maintained.

As illustrated in FIG. 3, the preferred embodiment also includes an elongated top portion 207 that contains a strap slot 204 through which a neck strap (or other attachment device) can be inserted for hanging, e.g., from a lanyard or neck chain. Further this slot has a circular element (top and bottom—205, 206) as part of its geometry in order to accommodate hingeable plastic snaps, rings, “J” hooks or ball chain (neck) in lieu of a strap.

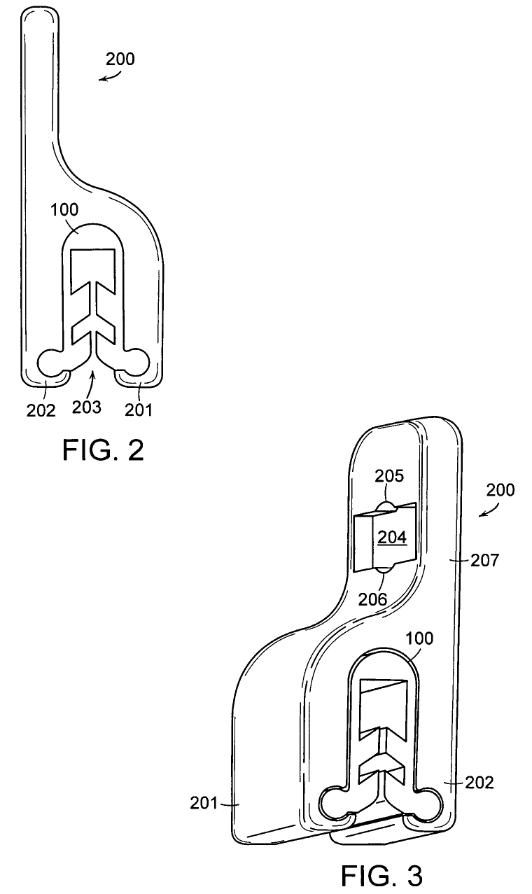

As best illustrated in FIGS. 2 and 3, the preferred card holder 200 of the present invention provides a unique design that will compete with the other devices currently on the market which also seek to avoid creating a “slot” in identification and other similar cards. Most of the competitive devices are built on the common spring-actuated, bull-dog clip principle which may include a soft rubber surface under compression in contact with the card to create a holding force. Other devices are the bag-type card holders which are difficult to use, since in order to securely hold the card, they are typically tight fitting, which makes it difficult to remove the card.

### Example

### Gripper 30

The Gripper 30's unique design is “card-friendly” while ensuring that the card is securely held, and is available as a lower cost alternative to competitive products. It accommodates industry-standard ID/access cards of 30 mil thickness and has no metal parts to set off detectors. The Gripper 30 has a plastic shell that is about 11/16 inches wide by about 1 inch high, with a silicone inner core with spaced fingers embedded therein. At the top of the holder, a slot is provided for connection to a holding member. The Gripper 30 will hold cards with up to 5 lbs. of vertical force and greater than 5 lbs. of horizontal force. Cards are easily attached and displayed. If desired, the product may be sized to hold larger cards (or groups of cards) of 40 mil thickness, 50 mil thickness, or the like. Likewise, cards of smaller thickness ranges can be held, either singularly or in groups.

Commercially available in black color, the Gripper 30 may also be imprinted in one color for additional promotional impact. Other colors can readily be produced as well if desired.

The Gripper 30 is an innovative and economical alternative to other mechanical holding devices. Its ability to hold cards without the need for a slot hole means that the technology (smart chip, antennae, etc.) resident in HID and other access cards can't be damaged. It is designed to work with virtually every existing badge reel, lanyard and strap clip available—so no additional hardware is required.

It will be recognized by those skilled in the art, that variations and modifications of the invention as disclosed and described herein may be accomplished. The scope of the present invention, therefore, is to be measured by the annexed claims.

What is claimed is:

1. A holder for card-like items comprising:
an outer shell having a pair of parallel arms connected in a spaced apart relationship forming one open end and one closed end, each arm at the open end having an inner and outer surface; and
means for gripping one or more card-like items, positioned between the inner surfaces of the parallel arms.

2. A holder as in claim 1, wherein the outer shell is composed of a plastic material.

3. A holder as in claim 2, wherein the plastic material is Acrylonitrile-Butadiene-Styrene (ABS).

4. A holder as in claim 1, wherein the gripping means comprises resilient material.

5. A holder as in claim 4, wherein the resilient material is composed of a silicone rubber.

6. A holder as in claim 5, wherein the resilient material forms a single insert that fits between the parallel arms.

7. A holder as in claim 6, wherein the resilient material comprises a plurality of flexible fingers.

8. A holder as in claim 7, wherein the fingers are disposed such that at least one finger on each parallel arm extends inwardly from the inner surface of the parallel arm, whereby the fingers form a pathway adapted to accept and hold one or more card-like items.

9. A holder as in claim 7, wherein the fingers on each parallel arm are directly opposed to those on the opposite arm and point away from the opening of the pathway.

10. A holder as in claim 9, wherein the resilient material forms a unitary insert that contains the fingers and attaches to both parallel arms.

11. A holder as in claim 1, wherein the resilient material is composed of a silicone rubber.

12. A holder as in claim 1, wherein the holder further comprises a means for hanging the outer shell from another object.

13. A holder as in claim 12, wherein the hanging means comprises an opening through the closed end of the holder.

14. A holder as in claim 12, wherein the hanging means comprises a top portion extending from the closed end of the outer shell and having an opening through the top portion.

15. A card holder comprising:
(a) an outer shell comprising plastic material, with two spaced apart parallel arms extending from a top portion;
(b) gripping means comprising a unitary insert made of silicone rubber, with at least one finger pointing inwardly from the inner surface of each parallel arm; and
(c) hanging means is provided in the top portion that extends away from the fingers, the hanging means being adapted to receive another attachment device or member.

16. The card holder of claim 15, wherein the plastic shell is about 11/16 inches wide by about 1 inch high.

17. The card holder of claim 15, wherein two fingers are provided inside each parallel arm.

18. The card holder of claim 15, wherein up to 5 lbs. of vertical force is required to remove a card from the holder.

19. The card holder of claim 15, wherein more that 5 lbs. of horizontal force is required to remove a card from the holder.

20. The card holder of claim 15, wherein the gripping means is sized to hold a cards having a size selected from the group consisting of 30 mil, 40 mil, and 50 mil thickness.
